(19) United States
(12) Patent Application Publication
(10) Pub. No.: US 2005/0234579 A1
(43) Pub. Date: Oct. 20, 2005

(54) Tractable nonlinear capability models for production planning

(76) Inventors: Jakob Asmundsson, Reykjavik (IS); Ronald L. Rardin, West Lafayette, IN (US); Reha Uzsoy, West Lafayette, IN (US)

Correspondence Address: Schwegman, Lundberg, Woessner & Kluth, P.A., P.O. Box 2938, Minneapolis, MN, 55402, US

(21) Appl. No.: 11/041,908

(22) Filed: Jan. 24, 2005

Related U.S. Application Data
(60) Provisional application No. 60/539,058, filed on Jan. 23, 2004.
(60) Provisional application No. 60/542,936, filed on Feb. 9, 2004.
(60) Provisional application No. 60/610,022, filed on Sep. 15, 2004.

(51) Int. Cl. G06F 19/00

(52) U.S. Cl. 700/102; 700/99

(57) ABSTRACT

A method for production planning in capacitated supply chains using non-linear clearing functions.

### RELATED APPLICATIONS

This application claims the benefit under 35 U.S.C. 119(e) of the following:
U.S. Provisional Application Ser. No. 60/539,058, filed Jan. 23, 2004 (Appendix I attached hereto);
U.S. Provisional Application Ser. No. 60/542,936, filed Feb. 9, 2004 (Appendix II attached hereto); and
U.S. Provisional Application Ser. No. 60/610,022 filed Sep. 15, 2004, all of which applications are incorporated by reference and made a part hereof.

### TECHNICAL FIELD

The present invention relates generally to improved methods and systems for supply chains in capacitated systems and in particular to management of product input and output in facilities and organizations.

### BACKGROUND

Any organization where materials are input into the system, processed in some manner and then output to come inventory has long struggled with how to manage the many variables that are present in the system.

Models have been used to more closely model these systems with varying degrees of success. Queuing and simulation models have been used for performance analysis, though such modeling has revealed that system performance measures are affected by the system's current utilization. For example, as system utilization approaches 100%, lead times increase in a non-linear fashion in both mean and variance. Aggregate planning models suffer from the need to use fixed estimates of lead times, which in turn results in a fundamental circularity, in that the model determines the amount of work to be released into the system in a given time period, determining the utilization, and in turn determining the lead times that will be realized.

What is needed is a system that can accurately model the non-linear relationship between workload and lead times to more efficiently manage and plan production in a capacitated supply chain.

### SUMMARY OF THE INVENTION

According to one example embodiment of the inventive subject matter, there is provided method and apparatus for production planning in capacitated supply chains using non-linear clearing functions. According to one example embodiment, there is determined a time period for measurement. An unambiguous work-in-process (WIP) to represent the WIP over the time period is defined. Further, the defined WIP is utilized to define an estimated clearing function. The estimated clearing function is applied to the production system under analysis. The current conditions of the production system are analyzed, and work is released into the production system based on the analysis.

### BRIEF DESCRIPTION OF THE DRAWINGS

FIG. 1 is a graphical, exemplary view of clearing function embodiments described herein.

FIG. 2 is a graphical view illustrating embodiments of utilization as a function of an average WIP for different c values.

FIG. 3 is a schematic view illustrating material flow conservation in one clearing function model embodiment.

FIG. 4 is a graphical view of clearing function, linear approximation and optimal solution embodiments for PCF.

FIG. 5 is a graphical view of throughput and demand embodiments of ACF and FC models.

FIG. 6 is a graphical view of WIP and FGI level embodiments, cumulative across items.

FIG. 7 is a graphical view of an embodiment of production lead-time across all items.

FIG. 8 is a graphical view of a marginal cost of capacity, MCC, embodiment.

FIG. 9 is a graphical view of a nonlinear relationship embodiment between throughput and lead time.

FIG. 10 is a graphical view of an embodiment of lead-time versus WIP, wherein Little's Law is satisfied.

### DESCRIPTION

A fundamental problem in developing effective production planning models has been their inability to accurately reflect the nonlinear dependency between workload and lead times. In the first part of this two-part paper we focus on the relationship between capacity, which we interpret as expected throughput, and workload at an aggregate level using nonlinear Clearing Functions to capture the lead-time dynamics accurately in a mathematical programming model for production planning. A partitioning scheme is introduced to allocate capacity across products, capturing the effects of varying product mix. We then present a linear programming formulation based on outer linearization of the nonlinear clearing functions that is able to capture the nonlinear dynamics observed between capacity, lead-time and workload in a tractable manner. The second part of this paper (Asmundsson et al. 2004) provides extensive computational experiments validating the approach and comparing its results to more conventional models.

1 Introduction

Models of production and distribution systems have been developed in the operations research and management science literature since the initial emergence of these fields. A fundamental issue in this area has always been the development of computationally tractable models that accurately reflect the operational dynamics of the systems under study. Queuing models have revealed that critical system performance measures, especially lead times, are affected by the workload on the system relative to its capacity, or its utilization. In particular, lead times increase nonlinearly in both mean and variance as system utilization approaches 100%. Hence, deterministic production planning models have suffered from a fundamental circularity. In order to plan production in the face of time-varying demands, they often use fixed estimates of lead times in their planning calculations. However, the decisions made by these models determine the amount of work released into the facility in a given time period, which determines the utilization and, in turn, the lead times that will be realized.

In this paper we propose a mathematical programming framework for modeling capacitated production systems that captures the nonlinear relationship between workload and lead times. We use the idea of clearing functions (Graves 1985; Karmarkar 1989; Srinivasan et al. 1988) that define the expected throughput of a capacity-constrained resource in a planning period as a function of the average work in process inventory (WIP) at the resource over the period, and discuss a number of ways in which they can be estimated. We then present a mathematical programming model of a single-stage production system that uses this approach, extend this to a multistage system and propose a linear programming formulation that effectively approximates this for computational purposes. The second part of this paper (Asmundsson et al. 2004) provides extensive computational experiments validating the models developed in this paper against extensive simulations of a production system, and comparing the performance of the production system under the different production plans obtained by this model as well as conventional linear programming model with fixed lead time estimates.

In the following section, we give a brief review of how capacity has been modeled in previous work on production planning. We then present the basic ideas of using clearing functions to model capacitated resources in a production system, and formulate an intuitive model of a single-stage production-inventory system based on these concepts. However, this intuitive model has a major flaw which must be rectified for the model to effectively address multiple product situations. We develop an extended formulation that successfully addresses this difficulty, and extend it to multistage systems. This extended formulation, which in general is nonlinear, is approximated by a linear programming formulation based on outer approximation. We provide a small computational illustration of the performance of the model on a simple single-stage system to illustrate how the plans developed in this way differ from those obtained by more conventional linear programming models. Extensive computational experiments validating the models proposed and comparing their performance to conventional linear programming models are presented in the second part of this paper (Asmundsson et al. 2004).

2 Existing Planning Models

The concept of manufacturing capacity is widely discussed in both the industrial and academic literature. However, as Elmaghraby (1991) points out, accurate measurements of manufacturing capacity are surprisingly hard to obtain. It is well known that the amount of product that can be produced by a capacitated resource, or set of resources, over some period of time depends on the product mix, the lot sizes, the amount of variability in the system, and the technology in use, which defines how different products interact in terms of capacity. There are also cases where the system output is constrained by external elements, such as the demand for the final product or the availability of raw materials. The effects of these different factors on system performance have been examined by a number of authors, such as Hopp and Spearman (2000) and Karmarkar (1985, 1989, 1993).

The literature on modeling production systems can be classified into two main categories. The first of these are stochastic performance analysis models, whose objective is to characterize system performance measures based on a probabilistic model of the operational dynamics of the system under study. Within this class of models, queuing models have been shown to capture important aspects of system behavior (e.g., Hopp and Spearman 2000). A fundamental relationship exposed by queuing models is that system performance measures, especially lead times, degrade nonlinearly as system utilization increases. It is also interesting to note that this degradation of system performance begins to occur before the system utilization approaches 100%.

The other stream of literature has involved a number of deterministic techniques that all follow essentially the same paradigm. The objective of these models is to allocate capacity to alternative products over time in the face of estimated demands so as to optimize some measure of system performance. The basic approach is to divide the planning horizon into discrete time buckets and assign the capacity in each bucket to products in a manner that satisfies a set of constraints that represent system capacity and dynamics at an aggregate level. The most important such constraint for the purposes of this paper is that which captures resource capacities as a fixed number of hours that can be utilized in each time bucket. The difficulty with this approach is that a solution that satisfies the aggregate constraints may well turn out to be impossible to execute since the operational dynamics are not modeled explicitly. Those dynamics manifest themselves in lead times. Many production systems operate under regimes that cause them to have substantial lead times, which must be considered in order for a planning system to match supply to demand. However, per the queuing models, lead-time depends on the workload in the system, which in turn is determined by the assignment of work to resources by the planning models. This constitutes a fundamental circularity in planning.

There have been two basic approaches to this problem in the literature. The first is to assume fixed lead times that are independent of system workload. The Materials Requirements Planning (MRP) approach presented by Orlicky (1975) uses fixed lead-times in its backward scheduling step to develop job releases. Assuming a fixed lead-time implicitly assumes infinite capacity, since it assumes that regardless of the workload, all work can be completed in a fixed amount of time. The difficulties introduced by this, such as the well-known MRP Death Spiral, were soon noted in practice and led to a number of enhancements aimed at checking whether the plans generated by MRP were indeed. Of these, Rough-Cut Capacity Planning (RCCP) does not use lead-time estimates at all, while Capacity Requirements Planning (CRP) assumes fixed lead times and applies capacity requirements to the MRP plan (Vollmann et al. 1983). Hence neither of these approaches can resolve the fundamental issue of the infinite capacity assumption. The Capacitated Material Requirements Planning (MRP-C) of Tardif and Spearman (1997) extends MRP to account for limited capacity. This procedure generates capacity feasible plans that minimize finished goods inventory. However, when components share a common resource, the capacity allocation has to be pre-specified by the user.

The most common mathematical programming approaches are linear programming (LP) models, of which a wide variety exist. In almost all of these models, capacity is modeled as a fixed upper bound on the total amount of a resource that can be consumed in a time period. This approach to modeling capacity leads to a number of problems. First of all, these models tend not to be able to distinguish between finished goods inventories (FGI) between production stages and WIP in the production process. This is because linear programming models, as pointed out by Hackman and Leachman (1989), implicitly assume that production is uniformly distributed across the time period and takes place instantaneously. Hence, if we were to develop an LP model with both WIP and finished goods inventories that were modeled distinctly, under most reasonable assumptions on inventory holding costs (specifically, that inventory holding costs are non-decreasing in the amount of processing that has been completed on the product), it is more economical to hold finished goods inventory at the previous stage instead of work in process inventory at the current one. Another interesting anomaly is that under these formulations the marginal cost of capacity is zero until the capacity constraint is saturated, which in queuing terms implies 100% utilization. However, both queuing models and industrial experience suggest that system performance, especially lead times, begins to degrade long before utilization reaches 100%, implying a positive marginal cost for capacity at lower utilization levels (Banker et al. 1986; Morton and Singh 1989; Srinivasan et al. 1988). A third difficulty with these models, and indeed with all models based on discrete time periods, is that they require changes in production rates, product mixes and inventory levels from one period to another. However, they do not model the dynamics of the production system that govern these changes in detail, which may cause them to propose plans that the system is unable to execute since the system is incapable of changing production rates and product mixes as rapidly as the model suggests.

Hackman and Leachman (1989) present a generic linear LP formulation for production planning that minimizes holding and production cost in multistage systems. They model capacity as a fixed upper bound on the number of hours available at the resource in a time period, and model input and output time-lags between stages for each item that need not be integer multiples of the underlying time-period of the model, unlike previously proposed models, e.g. that of Billington et al. (1983). However, these time lags are specifically independent of the workload, and represent delays such as transportation, curing time or batching rather than delays due to congestion in production due to limited capacity. They specifically do not discuss the time lags incurred due to congestion within the production nodes. The model presented later in this paper is essentially an extension of this model that addresses the issue of lead times due to congestion at capacitated production resources.

The second main approach to the fundamental circularity has been the use of detailed simulation or scheduling models to determine whether a proposed plan is actually executable. These systems typically model the processing of individual tasks on individual resources in detail, and hence capture the operational dynamics of the system correctly. A number of commercially available production planning systems follow this approach (e.g., Pritsker and Snyder 1993). Roux et al. (1999) address this issue by using a detailed scheduling model to check whether the plans their integer programming model develops are indeed feasible. A number of approaches use simulation models in the same manner, in some cases, the simulation model provides a detailed plan to be followed. The main difficulty with this approach is that it usually does not scale well, since the number of decisions to be made at the shop level tends to grow combinatorially with the number of resources and products, and even simulation models of large systems such as supply chains become difficult to maintain and time-consuming to run and analyze.

An innovative approach to integrating the two approaches is that of Hung and Leachman (1996). Given initial lead-time estimates, an LP model for production planning is formulated and solved. The resulting plan is fed into a simulator to estimate the lead-times the plan would impose on a real system. If these lead-times do not agree with the lead-times used in the LP, the LP is updated with the new lead-time estimates and resolved. This fixed-point iteration is repeated until convergence. However, convergence is not guaranteed and may depend on the structure of the underlying production system.

In summary, we see that previous work in this area has taken essentially two paths: aggregate models that are usually computationally tractable but cannot account for operational dynamics, or the incorporation of detailed, transaction-level simulation or scheduling models whose computational burden increases rapidly with the size of the system considered. In the following section we build on the idea of clearing functions to develop a tractable planning model that captures the nonlinear operational dynamics of load and lead times.

3 Clearing Functions

The basic idea of clearing functions is to express the expected throughput of a capacitated resource over a given period of time as a function of some measure of the system workload over that period, which in turn will define the average utilization of the production resources over that period. This workload, in turn, is viewed as being defined by the average work in process inventory (WIP) level in the system over the period. For the sake of brevity we shall use the term “WIP” to denote any reasonable measure of the WIP inventory level over a period of time that can be used as a basis for a clearing function. We shall visit this issue later in the paper.

From a modeling point of view, the objective is to develop an optimization model of a multistage production system where each capacitated resource is represented by constraints relating its throughput in a planning period to the average WIP at that stage over that period. When combined with suitable inventory balance constraints and an appropriate objective function, this allows us to model multistage systems in essentially the same manner as the LP models of Hackman and Leachman (1989), with the significant difference that the nonlinear operational dynamics induced by the presence of capacitated resources prone to congestion are captured to some degree of approximation by the clearing functions. Hence in this paper our discussion will initially focus on modeling a single-stage system. Once a meaningful single stage model has been developed, multistage systems can be modeled by linking the models of the individual stages together in a manner closely following the analogous LP models.

In the first paper to use the term “clearing function”, Graves (1985) proposes the use of constant clearing factors in a closed queuing analysis to aid in the estimation of lead-times for use in planning methods such as MRP or other linear programs that use fixed lead-time parameters. The clearing factors α specify the fraction of the available WIP that is cleared (i.e., processed to completion) in each period, i.e.,
Expected Throughput=α·WIP (1)

Given that the same proportion of the WIP is always cleared, average lead-time can be calculated as the inverse of the clearing factor, i.e. if a fraction α=0.25 of the WIP is cleared in each period then the last item to be added to the WIP in a given period must wait 4 (=1/0.25) periods in the queue. As with MRP, this approach does not consider finite capacity. Hence in periods with high WIP levels, the level of throughput suggested by this expression may be capacity infeasible. Srinivasan et al. (1988) and Karmarkar (1989) extend this work with a view to incorporating it into a mathematical program. They introduce clearing factors α(WIP) that are nonlinear functions of WIP, yielding
Expected Throughput=f(WIP) (2)
where f(WIP) is referred to as a clearing function, to be interpreted as the expected throughput of the resource in a given period for a given average WIP level over that period.

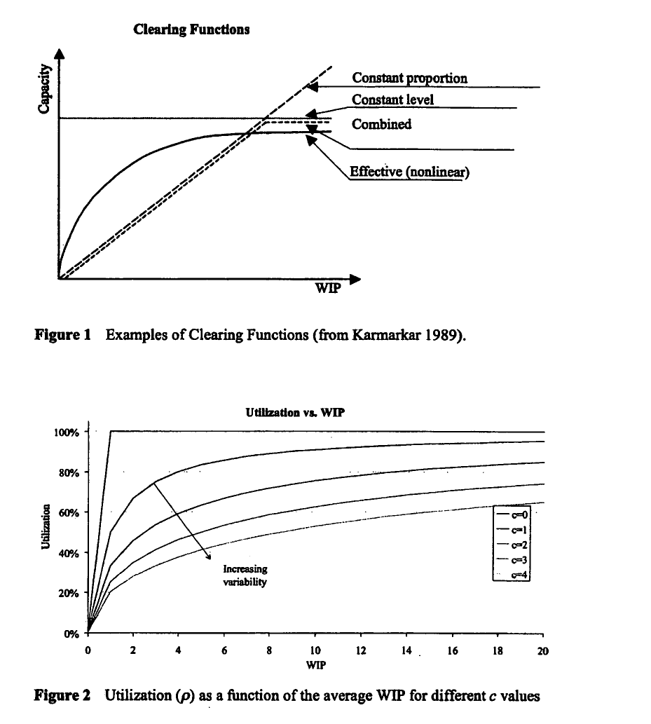

FIG. 1 from Karmarkar (1989) depicts several examples of clearing functions considered in the literature to date. The “constant proportion” clearing function of Graves (1986) allows unlimited output in a planning period, but ensures fixed lead-time, just like MRP. The “constant level” function corresponds to a fixed upper bound on output over the period, but without a lead-time constraint it implies instantaneous production, since production occurs without any WIP in the system. This is reflected in the independence of output from the WIP level, which may constrain throughput to a level below the upper bound by starving the resource. Typical LP formulations enforce an upper bound on output via an aggregate capacity constraint and allow the possibility of output being constrained by available inventory levels through the presence of inventory balance constraints. This approach is implemented in, for example, the MRP-C approach of Tardif and Spearman (1997) and the LP approaches of Hackman and Leachman (1989) and Billington et al. (1983). In the following section we define an effective clearing function, which reflects more accurately the behavior of a congestion-prone resource.

3.1 Effective Clearing Functions

We use the term “effective” clearing function to denote the clearing function that a capacitated resource forming part of a larger production system is likely to experience. Recall that our objective is to model a multistage production system by linking models of individual stages. Hence this section will focus on single stage models, which will then be combined into a multi-stage model in the following section.

A variety of authors have discussed the relationship between system throughput and WIP levels. This is usually in the context of queuing analysis, where the quantities being studied are the long-run steady-state expected throughput rate and WIP levels. An example of this work is that of Agnew (1976), who studies this type of behavior in the context of optimal control policies. Spearman (1991) presents an analytic congestion model for closed production systems with IFR processing times that describes the relationship between throughput and WIP in such a system. Standard texts on queuing models of manufacturing systems, such as Buzacott and Shanthikumar (1993) can be used to derive the clearing function—if not analytically, then at least numerically. Hopp and Spearman (2000) provide a number of illustrations of effective clearing functions for a variety of systems. Srinivasan et al. (1988) derives the effective clearing function for a closed queuing network with a product form solution.

To motivate the use of a nonlinear effective clearing function, it is helpful to begin with a single resource that can be modeled as a simple G/G/1 queuing system. The following expression (3) describes the average number in system, or equivalently expected WIP, for a single server where the coefficient of variation for service time and arrivals are denoted by cₙ and cₛ respectively (see Medhi 1991 for the derivation) and ρ denotes the utilization of the server.

$$WIP = \frac{{c}_{a}^{2} + {c}_{s}^{2}}{2} \frac{{ρ}^{2}}{1 - ρ} + ρ = \frac{{c}^{2} {ρ}^{2}}{1 - ρ} + ρ \qquad ( 3 )$$

Solving for ρ, we obtain utilization as a function of WIP as:

$$ρ = \frac{\sqrt{{( WIP + 1 )}^{2} + 4 WIP ( {c}^{2} - 1 )} - ( WIP + 1 )}{2 ( {c}^{2} - 1 )} \qquad ( 4 )$$

If we consider the utilization as a surrogate measure of output, FIG. 2 illustrates the relationship for different c values, where the coefficients of variation of the arrival and service (production) processes have been combined into c as seen in (3). First, we observe that for a fixed c value, utilization, and hence throughput, increases with WIP but at a declining rate. This is because as utilization increases, the server becomes less likely to starve. Utilization decreases as c increases, due to variability in service time and arrival rate, which causes queues to build up and throughput to slow as a number of customers are trapped behind a customer with an unduly long service time, or the number of customers arriving in a small time interval is unexpectedly high.

It is interesting to note, as pointed out by Karmarkar (1989, 1993), that this type of relationship between WIP and throughput can be observed in completely deterministic systems with batching. Previous work on the effects of lot sizing on manufacturing performance (e.g., Karmarkar et al. 1985) implies that lot sizing decisions would also affect the shape of the effective clearing function. Intuitively, one would expect a lot sizing policy that creates too many small batches to spend too much of the resource's time in setup changes, hence shifting the effective clearing function downwards. The implications of lot sizing for system performance are discussed in more detail by Karmarkar et al. (1985). However, in this paper we shall assume that lot sizing does not have a significant effect on system performance, i.e., setup times are negligible, leaving this question to future research.

It is important to realize that in any practical application we will, in general, not be able to define the effective clearing function completely due to the myriad of practical details that will affect system operation and output. Instead, we are forced to work with some estimate of the effective clearing function based on empirical data. We will refer to this as the estimated clearing function. Our objective in this work will be to develop estimated clearing functions that represent system behavior to a sufficient degree of accuracy for the aggregate plans derived using these functions to be of practical use.

Two approaches have been taken in the literature to developing estimated clearing functions for individual resources. One is analytical derivation from queuing models as shown earlier. Srinivasan et al. (1988) perform a similar study for a job shop with a fixed number of jobs represented as a Markov chain. Typically, analytical solutions such as these are ill suited for use in a mathematical program. Alternatively, Karmarkar (1989) and Srinivasan et al. (1988) suggest the use of the following functional forms that can be either fitted to empirical data or used to approximate analytical results such as those mentioned. Respectively they are:

$$\begin{matrix}f ( W ) = \frac{{K}_{1} W}{{K}_{2} + W} & ( 5 ) \\ f ( W ) = {K}_{1} ( 1 - {ⅇ}^{- {K}_{2} W} ) & ( 6 )\end{matrix}$$

where K₁ and K₂ are parameters to be determined by fitting the functions to empirical data. K₁ represents the maximum capacity f^{max}, and K₂ the curvature of the clearing function.

In a paper very similar in spirit to ours, Missbauer (2002) proposes an optimization model based on clearing functions for production planning. He distinguishes between two types of workcenters—potential bottlenecks and non-bottlenecks. Workcenters that are potential bottlenecks are modeled explicitly using clearing functions, while non-bottleneck workcenters are modeled as causing a fixed, load-independent time delay in flow between potential bottleneck stages, that essentially induces time lags of the form treated by Hackman and Leachman (1986). The emphasis is on using the clearing function based model as part of an order release system, where the model determines the amount of each aggregate product family to be released in a given time period. This aggregate release plan then forms the input to a short-term order release policy that selects specific orders for release into the job shop. The clearing function model is shown to yield better shop performance than an alternative load-based release scheme that assumes a stable system workload. However, this model differs from that presented in this paper in that the effects of product mix are not modeled, which we show in a subsequent section can cause significant difficulties.

In the context of production planning models, the basic philosophy of clearing functions is that of treating the production resource in a given time period as a queueing system that is in steady state over that period of time. The planning decisions determine the releases of work into the system, and the actual amount of production realized follows as a consequence. The fact that the actual number of entities in the system at any point in time will usually vary over the duration of the planning period forces us to substitute some estimate of the time average of the WIP level for the number of entities in the system. The production planning model determines the amount of each product released into the system in each time period, which affects the WIP level and hence the expected throughput in that time period. The implicit assumption here is that the planning periods are long enough for the steady state relationships to provide a sufficiently accurate picture of the performance of the system over that period. In addition, due to the discrete nature of the planning periods, release decisions at the boundary between two periods must, in a practical system, result in some transient behavior as the system moves from one state of operation to another. These behaviors will cause discrepancies between the realized behavior of the resource over the time period in question and that predicted by the clearing function.

In this work we do not explicitly address the issues related to transient behavior at the boundaries of planning periods, assuming that the planning periods are long enough that transient effects at the boundaries between periods can be safely neglected. We believe this is not an unrealistic assumption in practice. For example, in semiconductor manufacturing, the bottleneck resource in most fabs is the photolithography equipment, which takes of the order of 45 minutes to process a single lot of wafers. Given the high throughput of these facilities and a planning period of, say, a month, it is likely that the transient effects at the beginning and the end of a planning period will not significantly affect estimates of the average WIP level over the planning period. We explore some of these issues in our computational experiments in the second part of this paper, and demonstrate that even with these limitations, the planning models based on clearing functions provide significantly better production plans, in the sense defined above, than fixed lead time LP models.

In this paper we follow an empirical approach to estimating the clearing functions used in the planning model. We use a detailed simulation model of the facility under study to collect observations on the relationship between average WIP and average throughput in a planning period. In order to do this, we must address the issue of how to model the fact that different products consume resource capacity at different rates. To address this, we define ξᵢₜ as the amount of the resource required to produce one unit of product i in period t. We then measure the average WIP in terms of required resource usage, and define the expected throughput in terms of units of resource used in a time period. This allows us to express the capacity constraint based on the estimated clearing function in the form

$${\sum }_{i} {ξ}_{it} {X}_{it} \leq {f}_{i} ( {\sum }_{i} {ξ}_{it} {W}_{it} ) , for all t \qquad ( 7 )$$

where f is, for our current purposes, any concave function such that f(0)=0 (so that production cannot take place without WIP), and df/dW≧0. Note that both sides of the constraint are in units of time.

We have thus far motivated the use of concave clearing functions based on a queueing analogy, discussed previous work in the literature on developing estimated clearing functions, and presented the approach we will follow in this paper to developing the estimated clearing functions empirically using data collected from a simulation model. We have also outlined the manner in which we will use estimated clearing functions to model system capacity. In the following section we present a planning model for a single stage multiproduct production-inventory system, which constitutes the basic building block for the multistage systems we wish to model as an objective of this research. It is then straightforward to link models of individual stages into a multistage model, following essentially the same approaches as used in conventional LP formulations, such as those proposed by Hackman and Leachman (1989).

4. A Single Stage Multiproduct Planning Model Using Clearing Functions

Our starting point for developing planning models based on clearing functions is the single-product model given by Karmarkar (1989). Let us define the following decision variables:
Xᵢₜ=number of units of product i produced in period t
Rᵢₜ=number of units of product i released into the stage at the beginning of period t
Wᵢₜ=number of units of product i in WIP inventory at the end of period t
Iᵢₜ=number of units of product i in finished goods inventory at the end of period t

Let fₜ(W) denote the clearing function that represents the resource in period t, and Dᵢₜ the demand for product i (in units) in period t. Then a direct extension of Karmarkar (1989)'s formulation, which we shall refer to as the Clearing Function (CF) formulation, is

$$min {\sum }_{i} ( {ϕ}_{it} {X}_{it} + {ω}_{it} {W}_{it} + {π}_{it} {I}_{it} + {ρ}_{it} {R}_{it} ) \qquad ( 8 )$$

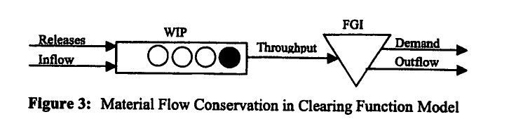

subject to

$$\begin{matrix}{W}_{it} = {W}_{i , t - 1} - {X}_{it} + {R}_{it} , for all i , t & ( 9 ) \\ {I}_{it} = {I}_{i , t - 1} + {X}_{it} - {D}_{it} , for all i , t & ( 10 ) \\ {\sum }_{i} {ξ}_{it} {X}_{it} \leq {f}_{t} ( {\sum }_{i} {ξ}_{it} {W}_{it} ) , for all t & ( 11 ) \\ {X}_{it} , {W}_{it} , {I}_{it} , {R}_{it} \geq 0 for all i , t & ( 12 )\end{matrix}$$

where φᵢₜ, ωᵢₜ, πᵢₜ, and ρᵢₜ denote the unit cost coefficients of production, WIP holding, finished goods inventory holding and releases (raw materials) respectively, and ξᵢₜ the amount of the resource (machine time) required to produce one unit of product i in period t. The first two sets of constraints enforce flow conservation for WIP and finished goods inventories (FGI), separately. Since the formulation distinguishes between WIP and finished goods inventory, flow conservation constraints are required for both types of inventories, as depicted in FIG. 3. The two different types of inventory serve two distinct purposes in this formulation. FGI buffers against demand variations at the end of the line. In periods when demand cannot be satisfied in a single period due to capacity limitations, FGI is carried over from previous periods. WIP, on the other hand, is accumulated at each node within the network due to jobs waiting in queue and jobs that are being processed. The amount corresponds to the expected WIP level in a system achieving the planned throughput rate. This way of modeling inventory is fundamentally different from traditional LP models since it links the expected throughput of the resource in period t to the WIP inventory position in that period. As a result, dramatic changes in WIP are unlikely to occur unless utilization levels drop significantly. It is unrealistic to see production levels fluctuate violently since it implies that WIP levels must fluctuate accordingly. We will see this in the computational example that concludes this paper.

We note in passing that this formulation incorporates the nonlinear dynamics in the right hand side of the constraints, as opposed to the work of Ettl et al. (2000) and Kekre (1984), where the nonlinear dynamics are embedded in the objective function by including term for the WIP costs in each period. In other words, in the CF model the degradation of system performance due to congestion is enforced as a constraint rather than just penalized. Another interesting contrast with most conventional formulations is that lead times do not appear anywhere, which avoids all the difficulties associated with using fixed lead time estimates that do not capture the nonlinear dynamics of the resources. Instead, the releases and lead times are jointly optimized, allowing lead times to vary dynamically over the planning horizon.

However, although this formulation is intuitive, it suffers from a major difficulty. As presented above, the model can create capacity for one product by holding WIP for another. A simple example consisting of two products, A and B, illustrates this clearly. The capacity constraint can be expressed as X_{A}+X_{B}≦f(W_{A}+W_{B}). A solution where X_{A}>0, X_{B}=0, W_{A}=0, and W_{B}>0 exists, contrary to what should be expected since there is not WIP to produce product A. Hence the optimal solution to this formulation maintains high WIP levels of the product for which it is cheapest to do so, and uses the capacity generated by this device (i.e., the high value of the estimated clearing function attained by holding high WIP of the cheap product) to hold very low or no WIP of all other products. An alternative way of expressing this difficulty is that there is no link between the mix of WIP available in the period and the production during the period.

In order to address this difficulty, we would like to find a way to decompose the overall clearing function f, which relates the total output from the system in the period to the total WIP level in the period, into a set of functions that depend only on the WIP position of product i in that period. In order to do this, we shall define a new set of variables Zᵢₜ≧0 that represent an allocation of the expected throughput represented by the clearing function among the different products, and use these allocated clearing functions to constrain the production level of each product, yielding the constraints

$$\begin{matrix}{X}_{it} \leq {Z}_{it} {f}_{t} ( {\sum }_{i} {ξ}_{it} {W}_{it} ) , for all i and t & ( 13 ) \\ {\sum }_{i} {Z}_{it} = 1 for all t & ( 14 )\end{matrix}$$

However, the right hand side is still in terms of the total WIP rather than the WIP of a specific product i. In order to address this, suppose we assume that the allocation of the clearing function (expected throughput) between products is proportional to the mix of products represented in the WIP in that period, i.e.,

$${ξ}_{it} {W}_{it} = {Z}_{it} {\sum }_{i} {ξ}_{it} {W}_{it} \qquad ( 15 )$$

In reality, this is an approximation; in a given period, we may choose to produce a larger amount of a more profitable product, perhaps exhausting the available WIP of that product, while choosing not to produce a less profitable product at all. Still, rearranging the latter expression and substituting the result into the clearing function constraints, we obtain the set of constraints

$$\begin{matrix}{X}_{it} \leq {Z}_{it} {f}_{i} ( {\sum }_{i} \frac{{ξ}_{it} {W}_{it}}{{Z}_{it}} ) , for all i and t & ( 16 ) \\ {\sum }_{i} {Z}_{it} = 1 for all t & ( 17 )\end{matrix}$$

The term

$${W}^{⋒} = \frac{{\sum }_{i} {ξ}_{it} {W}_{it}}{{Z}_{it}} \qquad ( 18 )$$

can be viewed as the extrapolated total WIP, since we are extrapolating the WIP Wᵢₜ of product i using the Zᵢₜ allocation factors to estimate the total WIP in that period. The combination of these constraints with the WIP and finished goods inventory balance constraints yields the following formulation, which we shall call the Allocated Clearing Function (ACF) formulation:

$$\begin{matrix}min {\sum }_{i} ( {ϕ}_{it} {X}_{it} + {ω}_{it} {W}_{it} + {π}_{it} {I}_{it} + {ρ}_{it} {R}_{it} ) \\ subject to & ( 19 ) \\ {W}_{it} = {W}_{i , t - 1} - {X}_{it} + {R}_{it} , for all i , t & ( 20 ) \\ {I}_{it} = {I}_{i , t - 1} + {X}_{it} - {D}_{it} , for all i , t & ( 21 ) \\ {X}_{it} \leq {Z}_{it} {f}_{t} ( {\sum }_{i} \frac{{ξ}_{it} {W}_{it}}{{Z}_{it}} ) , for all i and t & ( 22 ) \\ {\sum }_{i} {Z}_{it} = 1 for all t & ( 23 ) \\ {X}_{it} , {W}_{it} , {I}_{it} , {R}_{it} , {Z}_{it} \geq 0 for all i , t & ( 24 )\end{matrix}$$

We now show that the total expected throughput of the ACF model will never exceed that of the CF model in any period.

Proposition 1: Let f be any concave function, and Zᵢₜ≧0 a set of allocation variables as defined above. Then any solution that is feasible for ACF is also feasible for CF.

Proof: Since the WIP and finished goods inventory constraints are identical in both models, it is sufficient to focus on the capacity constraints and show that

$${\sum }_{i} {Z}_{it} {f}_{t} ( {\sum }_{i} \frac{{ξ}_{it} {W}_{it}}{{Z}_{it}} ) \leq f ( {\sum }_{i} {ξ}_{it} {W}_{it} ) . \qquad ( 25 )$$

To see this, note that by the concavity of f, we have

$$Q . E . D . \\ {\sum }_{i} {Z}_{it} {f}_{t} ( {\sum }_{i} \frac{{ξ}_{it} {W}_{it}}{{Z}_{it}} ) \leq \\ f ( {\sum }_{i} {Z}_{it} [ \frac{{ξ}_{it} {W}_{it}}{{Z}_{it}} ] ) = f ( {\sum }_{i} {ξ}_{it} {W}_{it} ) . \qquad ( 26 )$$

Note that the proof requires only the concavity off, so the result holds for any clearing function expressed as a concave function of WIP, including all of those defined previously in the literature. The result in Proposition 1 follows from the scheme we employ to extrapolate individual Wᵢ to a value to a surrogate for total WIP at which the clearing function can be evaluated. Then the expected throughput presumed available for i under this allocation (i.e., that set of Zᵢₜ values) is computed by applying fraction Zᵢ to the extrapolation function evaluation. If the extrapolations are exact, i.e. W=Wᵢₜ/Zᵢₜ for all i, then the sum of these allocated clearing capacities is exactly f(W). However, it is always a convex combination of the functional evaluations at various i, so that concavity assures it never exceeds f(W).

An important special case arises in production systems where we constrain all products to see the same average lead time. Assuming that the planning periods are long enough that a queueing model representing the operation of the resource during that period will approximately satisfy Little's Law, we will have

$${\sum }_{i} {ξ}_{it} {W}_{it} = ( {\sum }_{i} {ξ}_{it} {X}_{it} ) {L}_{t} \qquad ( 27 )$$

where Lₜ denotes the average lead time over all products. Assume now that we constrain the system such that all products must see the same average lead time Lₜ in a period. Then we have

$$\frac{{\sum }_{i} {ξ}_{it} {X}_{it}}{{\sum }_{i} {ξ}_{it} {W}_{it}} = \frac{{ξ}_{it} {X}_{it}}{{ξ}_{it} {W}_{it}} = {L}_{t} \qquad ( 28 )$$

Rearranging this, we obtain

$$\frac{{\sum }_{i} {ξ}_{it} {X}_{it}}{{ξ}_{it} {X}_{it}} = \frac{{\sum }_{i} {ξ}_{it} {W}_{it}}{{ξ}_{it} {W}_{it}} = \frac{1}{{Z}_{it}} \qquad ( 29 )$$

which yields

$${\sum }_{i} {ξ}_{it} {W}_{it} = \frac{{ξ}_{it} {W}_{it}}{{Z}_{it}} \qquad ( 30 )$$

which is what we used to obtain the ACF model. The intuition here is that allowing average lead times to vary across products introduces inefficiencies in the system, as we hold certain products back to allow others to be processed more rapidly. This reduction of system throughput due to prioritization of jobs has often been observed in scheduling research, where schedules optimizing due date performance tend to have lower throughput than those focused on throughput since they hold machines idle to allow high priority jobs to go through ahead of less important ones. This insight is also consistent with the results of the computational study reported in the second part of this paper, where we examine the effects of different scheduling policies on the clearing functions.

It is also instructive to compare the behavior of the two clearing function based models presented here to the corresponding linear programming model, which would be stated as follows:

$$min \sum \sum ( {π}_{it} {\hat{X}}_{it} + {h}_{it} {\hat{I}}_{it} ) \qquad ( 31 )$$

subject to

$$\begin{matrix}{\hat{I}}_{it} = {\hat{I}}_{i , t - 1} + {\hat{X}}_{i , t - L} - {D}_{it} for all i and t & ( 32 ) \\ {\sum }_{i} {ξ}_{it} {\hat{X}}_{it} \leq {C}_{t} for all t & ( 33 ) \\ {\hat{I}}_{it} , {\hat{X}}_{it} \geq 0 for all i and t & ( 34 )\end{matrix}$$

We use the notation Îᵢₜ and \hat{X}ᵢₜ for the finished inventory and production levels in each period to distinguish them from those obtained in the clearing function models. Cₜ denotes the total amount of time the resource is available in period t. Following the conventional LP approach, the system is assumed to have a constant lead time L. Production in period t becomes available to finished goods inventory, and hence available to satisfy demand, L time periods after its production. Hackman and Leachman (1986) give an extensive discussion of these types of time lags in LP models of production planning. We now show that if the clearing function is defined in a manner consistent with the aggregate capacity model used in the LP model, then any solution that is feasible for CF is also feasible for the LP model.

Proposition 2: Let Xᵢₜ denote the amount of product i produced in period t in the CF model. Then if we define the clearing function f such that f(W)≦Cₜ for all W≧0, any solution for the CF model is capacity feasible for the LP model, i.e.,

$${\sum }_{i} {ξ}_{it} {X}_{it} \leq f ( {\sum }_{i} {ξ}_{it} {W}_{it} ) \leq {C}_{t} for all i and t . \qquad ( 35 )$$

Proof: The fact that the production quantities obtained from the CF model will always be capacity-feasible for the LP model follows directly from the definition of the clearing function stated above. To obtain a feasible solution to the LP model, set
\hat{X}ᵢₜ=Xᵢₜ for all i and t
Note that the CF model is, like the LP model, constrained to meet all demand without backlogging. Hence in any period t, the cumulative production up to that period must exceed the cumulative demand. Thus there must exist a set of finished goods inventory values Îᵢₜ for the LP model that, together with the values constitute a feasible solution to the LP model.

Q.E.D.

Hence the LP model can be viewed as a relaxation of the CF models, rendering a direct comparison of the two models based on objective functions of doubtful value—the LP model is guaranteed to yield a better objective function value due to its being a relaxation of the CF and ACF models.

4 A Tractable ACF Formulation Using Outer Linearization

The models discussed thus far have been nonlinear in nature due to the presence of the clearing function. We now present a compact linear programming formulation that utilizes the partitioning scheme by representing the clearing function as a set of linear constraints using outer approximation. An added benefit of this approach is that it is not restricted to a particular functional form such as those proposed in Section 3, but can be obtained for any concave function. Since we assume the clearing functions are concave, they can be approximated by the convex hull of a set of affine functions of the form

$$\begin{matrix}{α}^{c} {\sum }_{i} {ξ}_{it} {W}_{it} + {β}^{c} as & ( 36 ) \\ f ( W ) = {min}_{c} \{ {α}^{c} {W}_{t} + {β}^{c} \} . & ( 37 )\end{matrix}$$

The c=1, . . . , C index represents the individual line segments used in the approximation. In order to represent the concave clearing functions appropriately, we shall assume that the slopes of the line segments are monotonically decreasing, i.e.,
α¹>α²> . . . >α^{c}=0.
The slope of the last segment is set to zero to indicate that the ultimate throughput capacity of the node has been reached, and adding WIP cannot increase throughput in a period. In order to ensure that production cannot take place without some WIP being present, we impose the additional condition β^{c}=0 to ensure that the first line segment will pass through the origin.

The capacity constraint in the CF formulation can now be replaced by the set of linear inequalities

$${\sum }_{i} {ξ}_{it} {X}_{it} \leq {α}^{c} {W}_{t} + {β}^{c} for all c and t . \qquad ( 38 )$$

Applying this outer linearization to approximate the ACF model yields the following LP formulation:

$$min {\sum }_{t} {\sum }_{i} ( {ϕ}_{it} {X}_{it} + {ω}_{it} {W}_{it} + {h}_{it} {I}_{it} + {ρ}_{it} {R}_{it} ) \qquad ( 39 )$$

subject to

$$\begin{matrix}{W}_{it} = {W}_{i , t - 1} - {X}_{it} + {R}_{it} for all i and t & ( 40 ) \\ {I}_{it} = {I}_{l , t - 1} + {X}_{it} - {D}_{it} for all i and t & ( 41 ) \\ {ξ}_{it} {X}_{it} \leq {α}^{c} {ξ}_{it} {W}_{it} + {Z}_{it} {β}^{c} for all i , t and c & ( 42 ) \\ {\sum }_{i} {Z}_{it} = 1 for all t & ( 43 ) \\ {Z}_{it} , {X}_{it} , {W}_{it} , {I}_{it} \geq 0 for all i and t & ( 44 )\end{matrix}$$

Notice that adding up the third set of constraints over all i gives constraint (38), guaranteeing that the original constraint is satisfied. A consequence of the partitioning of the clearing function is that the clearing function constraint becomes linear, even with the Z-variables that were originally in the denominator since

$$\begin{matrix}{Z}_{it} f ( \frac{{ξ}_{it} {W}_{it}}{{Z}_{it}} ) = {Z}_{it} {min}_{c} \{ {α}^{c} \frac{{ξ}_{it} {W}_{it}}{{Z}_{it}} + {β}^{c} \} \\ = {min}_{c} \{ {α}^{c} {ξ}_{it} {W}_{it} + {β}^{c} {Z}_{it} \}\end{matrix} \qquad ( 45 )$$

Notice that the capacity allocation appears in the product of the β coefficients with the Z variables. Recall that this parameter denotes the intercept with the y-axis. To explore this further we consider two extreme scenarios. Suppose the facility is extremely highly loaded and therefore has very high WIP levels. Under such circumstances, we are operating on the far right of the clearing function. Consequently, the a coefficients denoting the slope of the curve in the active constraints will all be zero and the β coefficients equal to the maximum throughput. In this case, the clearing function constraint resembles a fixed capacity constraint. This is consistent with what one should expect since utilization levels are at 100%.

On the other hand, suppose that the facility is extremely lightly loaded. WIP levels are close to zero and we are operating on the far left of the clearing function, close to the origin. In this case, the β coefficients in the active constraint will be zero and the capacity split between products not in effect. What is interesting to notice in this case is that the active clearing function constraints for all products at that node will be identical, i.e., Xᵢₜ≦α¹Wᵢₜ. This implies that the lead-time across all products is equal to 1/α¹. Since the lead time for a lightly loaded facility will be close to the raw processing time, queuing delays being negligible, this is consistent.

We have now obtained a LP model that represents the ACF formulation for a single stage production system. It is straightforward to extend this formulation to multiple stage systems using the same techniques as standard LP models. For the purpose of exposition, we shall assume that material transfer time between stages of the production/inventory system is negligible relative to the duration of the planning periods. The incorporation of various types of transportation delays and other time lags that do not encounter congestion phenomena is straightforward and is described at length by Hackman and Leachman (1989). We define the following notation:
t=index indicating time period
n=node index
i=item index (typically different products)
Dᵢₜⁿ=demand for item i at node n, during period t
ξᵢₜⁿ=capacity consumption per unit produced for item i at node n.
Xᵢₜⁿ=total production quantity over period t. The corresponding unit cost is denoted by φᵢₜⁿ.
Wᵢₜⁿ=WIP at of item i at node n at the end of period t. This includes all jobs in queue and in process. The corresponding unit cost is denoted by ωᵢₜⁿ.

Iᵢₜⁿ=finished goods inventory (FGI) of item i at node n at the end of period t with corresponding unit holding cost πᵢₜⁿ.
Rᵢₜⁿ=amount of raw material for item i at node n during period t with corresponding unit cost ρᵢₜⁿ.
Yᵢₜ^{nk}=amount of product i transferred from node n to node k in period t.
C(n)=set of indices denoting the line segments used in the piecewise linearization of the clearing function at stage n

Note that we have introduced a new set of variables, the Yᵢₜ^{nk}, denoting the amount of transfer between stages in each period. For the purposes of exposition, we shall assume that transfers between stages are instantaneous and not subject to congestion. Under these conditions, it is straightforward to model congestion-independent delays in transfers between stages using the approach of Hackman and Leachman (1989). The LP formulation representing the clearing function based formulation for a multiple stage production/inventory system can now be stated as follows:

$$min {\sum }_{t} [ {\sum }_{n} {\sum }_{i} ( {ϕ}_{it}^{n} {X}_{it}^{n} + {ω}_{it}^{n} {W}_{it}^{n} + {π}_{it}^{n} {I}_{it}^{n} + {ρ}_{it}^{n} {R}_{it}^{n} ) + {\sum }_{k} {δ}_{it}^{nk} {Y}_{it}^{nk} ] \qquad ( 47 )$$

subject to

$$\begin{matrix}[ Dual variables \text{:} {μ}_{it}^{n} ] \\ {W}_{it}^{n} - {W}_{i , t - 1}^{n} + {X}_{it}^{n} - {R}_{it}^{n} - {\sum }_{k} {Y}_{it}^{kn} = 0 for all n , i , t & ( 48 ) \\ [ Dual variables \text{:} {γ}_{it}^{n} ] \\ {I}_{it}^{n} - {I}_{i , t - 1}^{n} - {X}_{it}^{n} + {\sum }_{k} {Y}_{it}^{nk} + {D}_{it}^{n} = 0 , for all n , i , t & ( 49 ) \\ [ Dual variables \text{:} {λ}_{it}^{nc} ] \\ {α}_{ct}^{n} {ξ}_{it}^{n} {W}_{it}^{n} + {β}_{ct}^{n} {Z}_{it}^{n} - {ξ}_{it}^{n} {X}_{it}^{n} \geq 0 for all n , i , t , c ∈ C ( n ) & ( 50 ) \\ [ Dual variables \text{:} {σ}_{t}^{n} ] \\ {\sum }_{i} {Z}_{it}^{n} = 1 , for all n , t & ( 51 ) \\ {Z}_{it}^{n} , {X}_{it}^{n} , {W}_{it}^{n} , {I}_{it}^{n} , {R}_{it}^{n} , {Y}_{it}^{nk} \geq 0 for all n , i , t , k & ( 52 )\end{matrix}$$

Marginal Cost Calculations

We explore the dual prices of capacity and additional WIP in the following propositions. The dual of the formulation given above and the associated complementary slackness conditions are given in the Appendix. We make the following observation:

Proposition 3: In any optimal solution, for any node n, at most two of the linearized capacity constraints (50) can be tight. Hence at most two of the associated dual variables λᵢₜ^{nc} can be nonzero.

Proof: The case where two of these are tight corresponds to the case where the optimal Wᵢₜⁿ value is at the intersection of two of the line segments used to linearize the clearing function. We can interpret the dual variables λᵢₜ^{nc} as the cost imposed on product i in period t by congestion at node n. For the remainder of this section we shall assume, for ease of exposition, that only one of the linear constraints (50) is tight Let c* denote the index of this constraint. We then have the following results:

Proposition 4: When production of some item i takes place at node n in period t, i.e., Xᵢₜⁿ>0 for some i and t, the cost of congestion for product i at node n in period t at node n in period t is given by

$${λ}_{it}^{{nc}^{*}} = \frac{{μ}_{it}^{n} - {γ}_{it}^{n} - {ϕ}_{it}^{n}}{{ξ}_{it}^{n}} \qquad ( 53 )$$

The proof follows directly from the active dual constraint conditions. This expression can be interpreted as the net benefit of production, given by the reduction of WIP in period t minus the added benefit of finished goods inventory in the same period minus the unit production cost, scaled by the unit resource consumption of product i.

Proposition 5: When there is positive WIP of item i at node n in period t, i.e., Wᵢₜⁿ>0, the marginal value of additional WIP of product i is given by

$${μ}_{it}^{n} = {μ}_{i , t + 1}^{n} - {ξ}_{it}^{n} {\sum }_{c} {α}_{ct}^{n} {λ}_{it}^{nc} - {ω}_{it}^{n} . \qquad ( 54 )$$

Again, this result follows directly from the active dual constraint conditions. The marginal benefit of WIP is given by the marginal value of the additional output generated by that WIP, minus the benefit of WIP in the following period and the reduction in holding cost. It is also insightful to rearrange this into the form
μ_{i,t+1}ⁿ−μᵢₜⁿ=ξᵢₜⁿα_{c}ⁿ·λᵢₜ^{nc*}+ωᵢₜⁿ (55)
This indicates that at optimality, the marginal cost of carrying WIP from period t to period t+1 is equal to the marginal cost of congestion in period t plus the holding cost of WIP. This implies that the WIP holding cost is a lower bound on the marginal cost of maintaining WIP in the system.

It is interesting to compare the nature of the dual prices from this model with those from the standard linear programming model presented in Section 3. One can view the capacity constraint in the standard LP formulation as consisting of only the last segment of the linearization used above. Thus it is apparent that, since the linearized clearing function based formulation allows for the situation where other line segments are tight at optimality, the clearing function will generate better information on the marginal cost of congestion than the LP formulation. On the other hand, it is possible in both formulations that the demand is very low relative to capacity in some period, which would allow capacity constraints in both formulations to be nonbinding and yield zero dual prices for the capacity-related constraints in both models.

5 Implementing the ACF Formulation

At this point, we need to address a number of specific issues that have so far been left open in our relatively generic discussion of estimated clearing functions. First of all, we need to define an appropriate measure of WIP to use in defining the estimated clearing functions. There are two sets of issues here. The first is that of how to address the presence of different products that consume a resource at different rates. The second is due to the fact that the mathematical programming formulation we use divides the planning horizon into a number of time buckets. Clearly, in practice the WIP level in front of the resource will vary over the duration of this period, resulting in the need to define an unambiguous measure of WIP that we can use to represent the situation over the entire period. Similarly, the output of the resource is unlikely to be constant over the time-period, requiring similar treatment of the output measures. We must stress at this point that there are several different ways in which these issues can be addressed, and that those we have elected to use in our empirical work are by no means guaranteed to give the best results under all circumstances. Further research is necessary to understand exactly how to best address these issues under different production environments and modeling conditions.

We have already discussed how we address the first issue, that of the presence of multiple products, by defining resource consumption factors ξᵢₜⁿ. This is consistent with other formulations such as Hackman and Leachman (1989). An approach that addresses the second issue must specify how to relate WIP to throughput. A number of alternative approaches have been suggested. Srinivasan et al. (1988) use the WIP at the beginning of the period in a clearing function to establish the capacity during the entire period. However, if the periods are long, this may become inaccurate since WIP levels may vary significantly over the period.

Karmarkar (1989) suggests using total work content (TWC) defined as the WIP on hand at the beginning of the period, plus all inflow, i.e.

$${W}_{it}^{n} + {R}_{it}^{n} + {\sum }_{k} {Y}_{it}^{kn} .$$

Let

$${\hat{X}}_{i t}^{n} = \frac{1}{2} ( {X}_{i t}^{n} + {X}_{i , t + 1}^{n} )$$

be the throughput during the period. The capacity constraint now takes the form:

$$\begin{matrix}{\sum }_{i} {\hat{X}}_{i t}^{n} \leq {f}_{n t} ( {\sum }_{i} {W}_{i t - 1}^{n} + {R}_{i t}^{n} + {\sum }_{k} {Y}_{i t}^{k n} ) & ( 56 ) \\ = {f}_{n t} ( {\sum }_{i} {W}_{i t}^{n} + {\sum }_{i} {\hat{X}}_{i t}^{n} ) . & \end{matrix}$$

The second equality follows from the WIP balance equation with the new notation. This implies that a clearing function can be derived that is only a function of the ending WIP level. However, using the ending WIP also does not take into account possible changes in the WIP level.

Our approach is to formulate it by offsetting the production variables by half a period from what is traditionally done. Hence, the production variable Xᵢₜⁿ, can be used as an estimate of the production rate at time t by dividing it by the length of the time period. The clearing function “theoretically”, as for example seen from queuing theory, relates expected throughput in a given time period to the expected WIP over that period. This formulation allows us to state the capacity constraint accordingly.

Note that our approach to this problem is by no means the only possible one. The WIP level in the middle of period t can, for instance, be approximated by the average of the beginning and ending WIP for that period, i.e.

$$\frac{1}{2} ( {W}_{i t}^{n} + {W}_{i t - 1}^{n} ) .$$

The output during the period can therefore be defined as a function of the average WIP during the period. The problem we encountered with this approach in our preliminary experiments was that, since the same average WIP level can be achieved by many different beginning and ending WIP levels, the optimal WIP levels tend to oscillate. A problem instance requiring constant throughput over the entire planning horizon may have an optimal solution where WIP oscillates from 10 to 30 units from period to period, giving an average WIP level of 20 as required. Similar behavior is observed when the problem is formulated by interpreting the throughput at time t as the average of the throughput in periods t and

$$t + 1 , i . e . \frac{1}{2} ( {X}_{i t}^{n} + {X}_{i t + 1}^{n} ) \leq f ( {W}_{i t}^{n} ) .$$

The formulation used in our experiments can thus be stated as follows:

$$min {\sum }_{t} [ {\sum }_{n} {\sum }_{i} ( {ϕ}_{i t}^{n} {X}_{i t}^{n} + {ω}_{i t}^{n} {W}_{it}^{n} + {π}_{i t}^{n} {I}_{i t}^{n} + {ρ}_{i t}^{n} {R}_{it}^{n} ) + {\sum }_{k} {δ}_{i t}^{nk} {Y}_{it}^{nk} ] \qquad ( 57 )$$

subject to

$$\begin{matrix}{W}_{it}^{n} = {W}_{it - 1}^{n} - \frac{1}{2} ( {X}_{i t}^{n} + {X}_{i , t + 1}^{n} ) + {R}_{it}^{n} + {\sum }_{k} {Y}_{it}^{k n} for all n , i , t & ( 58 ) \\ {I}_{it}^{n} = {I}_{it - 1}^{n} + \frac{1}{2} ( {X}_{i t}^{n} + {X}_{i , t + 1}^{n} ) - {\sum }_{k} {Y}_{it}^{k n} - {D}_{i t}^{n} , for all n , i , t & ( 59 ) \\ {α}_{ct}^{n} {ξ}_{i t}^{n} {W}_{i t}^{n} + {β}_{ct}^{n} {Z}_{i t}^{n} - {ξ}_{i t}^{n} {X}_{i t}^{n} \geq 0 for all n , i , t , c ∈ C ( n ) & ( 60 ) \\ {\sum }_{i} {Z}_{it}^{n} = 1 , for all n , t & ( 61 ) \\ {Z}_{i t}^{n} , {X}_{i t}^{n} , {W}_{i t}^{n} , {I}_{it}^{n} , {R}_{it}^{n} , {Y}_{it}^{nk} \geq 0 for all n , i , t , k & ( 62 )\end{matrix}$$

6. A Computational Example

We now illustrate the application of this model to a computational example using a single stage system for purposes of exposition. While this example does not constitute a complete validation of the modeling approach for multistage systems, it illustrates how the solutions derived from the ACF model differ from those obtained from a conventional LP model. A detailed validation of the model on a multistage system is given in Part II of this paper (Asmundsson et al. 2004). We consider a simple of single stage system with three products that can be modeled as a G/G/1 queue with coefficients of variation in arrival and service of 0.5 and 2, respectively. This allows us to use the results in (4) to represent the clearing function. The period length chosen was such that the maximum throughput is equal to 10 items per period. The objective function is that of minimizing inventory holding cost, where the holding cost of item 2 is twice that of item 1, and holding cost of item 3 is 3 times that of item 1. Holding costs for WIP and FGI were taken to be equal.

For comparison purposes we use the conventional LP formulation described in Section 3 that closely follows Hackman and Leachman (1989), where capacity is modeled as an aggregate limit on total resource consumption over the period and lead-times are taken to be exogenous parameters, referred to as the Fixed Capacity (FC) model.

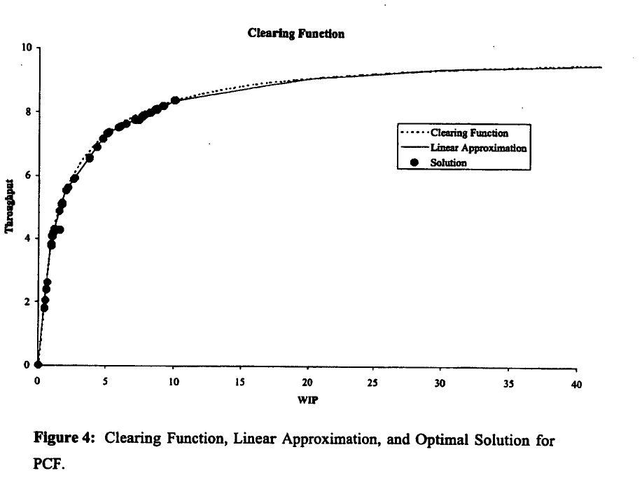

The clearing function is displayed in FIG. 4, along with the linear approximation used for the linear program. The optimal throughput levels are also included in the figure. Observe that they all lie on the curve or very close to it. Rather than using a fixed upper bound on capacity equal to 10 items per period, this value was set to 8 units per period. This estimate was based on the highest throughput value from the ACF model, implying that it is not cost effective to operate beyond 80% utilization. This gives much better results for the FC model than if we were to use 10 units as the capacity limit.

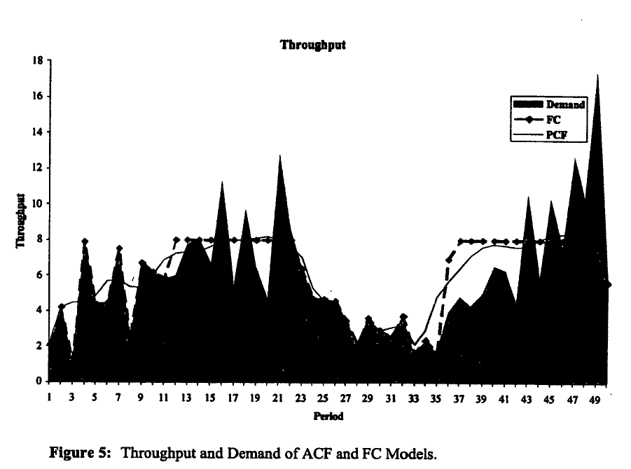

The cumulative throughput levels across all products for the two models are presented in FIG. 5. The demand data used in this experiment was randomly generated for each item. The cumulative demand across all items is show in the figure (gray area). The optimal throughput from ACF tends to be smooth compared to the FC throughput, since ACF captures the cost of building up and holding WIP to increase throughput in high demand periods

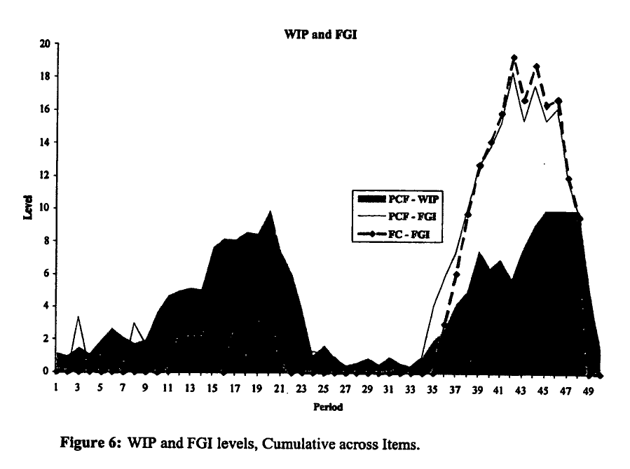

Recall that throughput and WIP are related via the clearing function. It is therefore interesting to look at the WIP profile for ACF, as seen in FIG. 6. We clearly see the relationship between the WIP profile and the throughput; WIP levels are high when throughput is high and vice versa. We also observe that the FGI levels are very similar for both models, but as expected the FC model does not capture WIP. What is interesting in this case is that WIP accounts for approximately 50% of the total inventory for the system. Hence the FC solution only optimizes the FGI holding costs, and fails to capture the tradeoffs between holding WIP and FGI. This becomes even more important for multistage systems, where the WIP may account for even a larger portion of total system inventory. The ACF solution holds FGI in some periods during the first 10 periods although the system is not highly loaded, because it is cheaper to hold some FGI than to shift WIP drastically from period to period in order to increase the production rate when demand peaks.

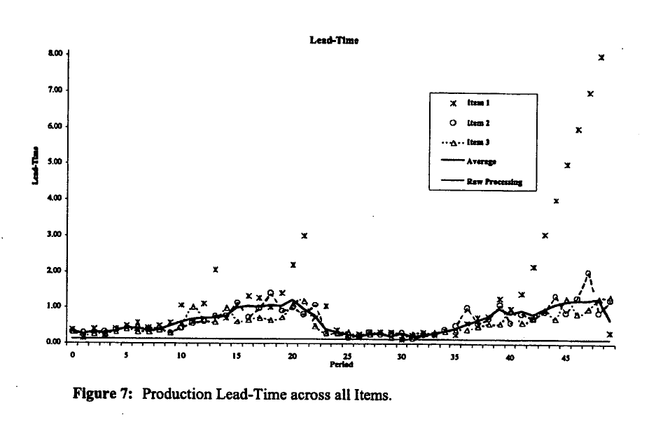

The production lead-time implied by the two models can be evaluated by comparing the cumulative releases to the cumulative output. Given that the cumulative production at time t and the cumulative releases at time t-L are the same. Then L is the lead-time, i.e. the time since the last job to leave the system entered the system. FIG. 7 shows the average production lead-time across all items (solid black line) and lead-times for individual items (dotted lines) for PCF. Production lead-time is defined as the time a job spends in WIP. First we notice that the lead-time is greater than 0.1 periods (solid grey line), which corresponds to the raw processing time, and varies significantly over the planning horizon. If a fixed-lead time were to be used as in traditional models—what lead-time estimate should be used?

The lead-time for item 1 is quite long in the last few periods due to its low holding cost relative to the other products. Most of the demand for that item is produced well ahead of time and kept in FGI to reserve capacity for the more expensive items when needed, although a very small portion of the demand for item 1 is still satisfied directly from production. The reason behind this is that so much inventory for this item is in the system and hence the production of this item is very efficient, i.e. the solution lies far to the right on the partitioned clearing function. Comparison of the average lead-time to the individual lead-times for the three items implies that the volume behind the high lead-time for item 1 is very low.

5.1 Marginal Cost of Capacity

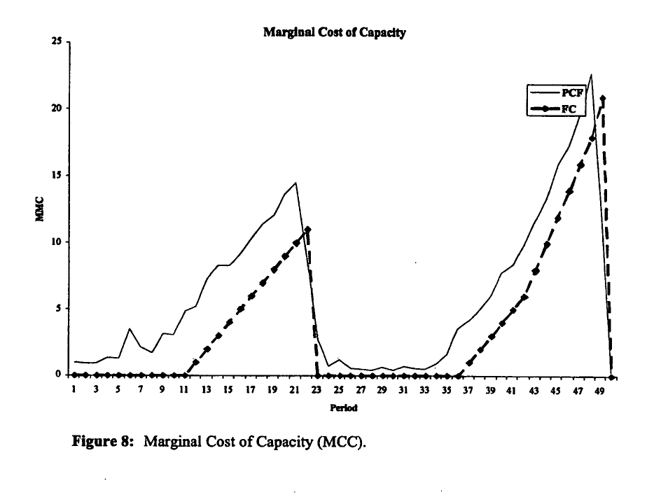

The capacity constraint in ACF is active and the marginal cost of capacity (MCC) is therefore positive throughout the entire planning horizon. This is illustrated in FIG. 8. In contrast, MCC=0 in FC for all periods where FGI is zero, since the capacity constraint is inactive. MCC increases from period to period when FGI remains positive, as is apparent from the figure. This occurs since as time passes and FGI remains positive, the number of days finished goods remains in stock increases accordingly. Keep in mind that if the workstation had ample capacity, such as a clear non-bottleneck station in a network of workstations, MCC would be zero in a FC model, but nonzero in a PCF model as long as throughput is positive.

5.2 Nonlinear Relationships

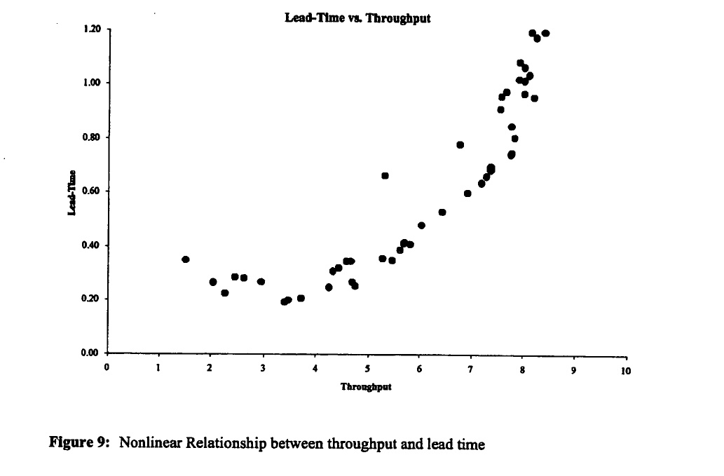

Finally, we observe the nonlinear dynamics associated with lead-time and utilization when we plot lead-time versus throughput as seen in FIG. 9.

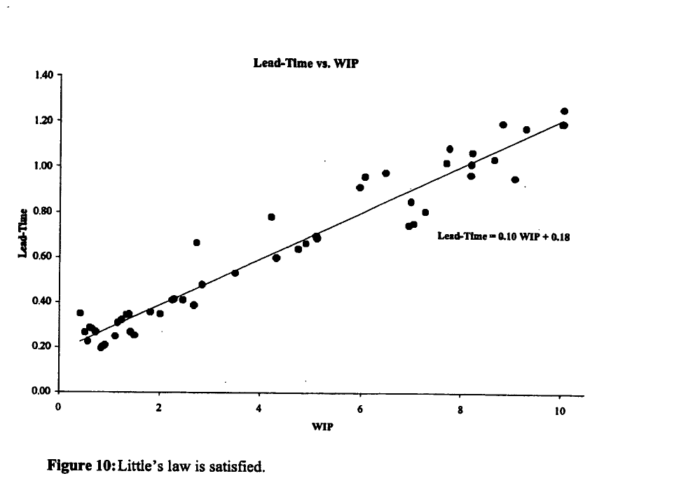

As throughput approaches 10 (the maximum capacity) lead-time increases nonlinearly as is to be expected. This is consistent with the queuing models we discussed previously. To increase throughput, WIP must increase, leading to longer lead-times. FIG. 10 plots lead-time as a function of WIP. As expected the relationship is linear, in agreement with Little's law. The slope of the line through the data points is equal to the average service time, i.e. 0.1 time periods. The presence of the intercept is due to the raw processing time of the system (a job entering an empty system will still need on average 0.1 time units to complete), and sampling error from the simulation runs.

### 6 CONCLUSIONS

We have presented a series of formulations of production planning problems that capture the nonlinear relationship between workload and lead time using the idea of clearing functions (Karmarkar 1989, Srinivasan et al. 1988). We extend previous work to multiproduct systems, and develop a linear programming formulation that approximates this formulation using outer linearization. A small computational example illustrates the differences between the solutions obtained by this formulation and those from a conventional LP formulation.

The generation of estimated clearing functions has been briefly discussed by use of queuing theory or empirical data obtained from simulation models or historical data. In the second part of this paper we address these issues in more detail, and present an in-depth computational validation of the clearing function approach using a simulation model of a manufacturing facility as a testbed.

### Acknowledgments

This research has been supported by The Laboratory for Extended Enterprises at Purdue (LEEAP), the UPS Foundation, and NSF Grants DMI-0075606 and DMI-0122207 through the Scalable Enterprise Systems Initiative. We also thank Dr. Alkis Vazacopoulos of Dash Optimization Inc. for supporting us through software donations. We used Xpress-IVE to model and solve the mathematical programs. The software allowed us to examine different scenarios and test our models against other modeling techniques with minimal programming effort. A U.S. patent application has been filed for the formulations in this paper.

### REFERENCES

Agnew, C. (1974). “Dynamic Modeling and Control of some Congestion-Prone Systems”, Operations Research, Vol. 24, No. 3, pp. 400-419.
Asmundsson, J. M., R. L. Rardin and R. Uzsoy (2004), “Tractable Nonlinear Capacity Models for Production Planning Part II: Validation and Computational Experiments”, Research Report, Laboratory for Extended Enterprises at Purdue, School of Industrial Engineering, Purdue University.
Banker, R. D., S. Datar and S. Kekre (1986), “Relevant Costs, Congestion and Stochasticity in Production Environments”, Journal of Accounting and Economics Vol. 10, 171-197.
Billington, P. J., J. O. McClain and L. J. Thomas (1983). “Mathematical Approaches to Capacity-Constrained MRP Systems: Review, Formulation and Problem Reduction”, Management Science, Vol. 29, No. 10, pp. 1126-1141.
Buzacott, J. A. and J. G. Shanthikumar (1993). Stochastic Models of Manufacturing Systems, Prentice Hall, Englewood Cliffs, N.J.
Elmaghraby, S. E. (1991), “Manufacturing Capacity and its Measurement: A Critical Evaluation”, Computers and Operations Research, Vol. 18, No. 17, pp. 615-627.
Ettl, M., G. Feigin, G. Y. Lin, and D. D. Yao (2000), “A Supply Chain Network Model with Base-Stock Control and Service Requirements”, Operations Research, Vol. 48, No. 2, pp. 216-232.
Fargher, H. E. and R. A. Smith (1994), “Planning in a Flexible Semiconductor Manufacturing Environment”, Intelligent Scheduling, M. Zweben and M. Fox (eds.), Morgan Kaufman, San Francisco, Calif.
Fox, M. S. and S. F. Smith (1984). “ISIS—a Knowledge Based System for Factory Scheduling”, Expert Systems, Vol. 1, No. 1, pp. 25-49.
Graves, S. C. (1985). “A Tactical Planning Model for a Job Shop” Operations Research, 34, pp. 552-533.
Hackman, S. T. and R. C. Leachman (1989), “A general framework for modeling production”, Management Science, Vol. 35, No. 4, pp. 478-495.
Hadavi, K, M. S. Shahraray and K. Voigt (1989), “ReDS: A Dynamic Planning, Scheduling and Control System for Manufacturing”, Journal of Manufacturing Systems, Vol. 4, pp. 332-344.
Hopp, W., and M. L. Spearman (1996), Factory Physics, Irvin.
Hung, Y and R. C. Leachman (1996). “A Production Planning Methodology for Semiconductor Manufacturing Based on Iterative Simulation and Linear Programming Calculations”, IEEE Transactions on Semiconductor Manufacturing, Vol. 9, No. 2, pp. 257-269.
Karmarkar, U.S. (1989). “Capacity Loading and Release Planning with Work-in-Progress (WIP) and Lead-times” Journal of Manufacturing and Operations Management 2, pp. 105-123.
Karmarkar, U.S. (1993). “Manufacturing Lead-times, Order Release and Capacity Loading”, Handbooks in Operations Research & Management Science Vol. 4: Logistics of Production and Inventory, S. C. Graves, A. H. G. Rinnooy Kan and P. Zipkin (eds.), 287-329.
Karmarkar, U.S., S. Kekre, S. Kekre, and S. Freeman (1985). “Lot-Sizing and Lead-time Performance in a Manufacturing Cell”, Interfaces, Vol. 15, No. 2, pp. 1-9.
Kekre, S., (1984), Some Issues in Job Shop Design, Unpublished ph.D. Thesis, Simon Graduate School of Business Administration, University of Rochester
Medhi, J. (1991). Stochastic Models in Queuing Theory, Academic Press.
Missbauer, H. (2002), “Aggregate Order Release Planning for Time-Varying Demand”, International Journal of Production Research 40, 699-718.
Morton, T. E. and M. R. Singh (1988), “Implicit Costs and Prices for Resources with Busy Periods”, Journal of Manufacturing and Operations Management, Vol. 1, 305-332.
Orlicky, J. (1975), Material Requirements Planning: the New Way of Life in Production and Inventory Management, McGraw-Hill, New York.
Pritsker, A. A. B., Snyder, K., “Production Scheduling Using FACTOR”, in The Planning and Scheduling of Production Systems, A. Artiba and S. E. Elmaghraby (eds.), Chapman and Hall (1997).
Roux, W., S. Dauzere-Peres, and J. B. Lasserre (1999). “Planning and scheduling in a multi-site environment”, European Journal of Operational Research, Vol. 107, No. 2, pp. 289-305.
Smith, S. F. (1992). “Knowledge-based production management: approaches, results and prospects”, Production Planning and Control, Vol. 3, No. 4, pp. 350-380.
Spearman, M. L., D. L. Woodruff and W. J. Hopp (1990). “CONWIP. A pull alternative to kanban”, International Journal of Production Research, Vol. 28, No. 5, pp. 879-894.
Spearman, M. L. (1991). “An Analytic Congestion Model for Closed Production Systems with IFR Processing Times”, Management Science, Vol. 37, No. 8, pp. 1015-1029.
Srinivasan, A., M. Carey and T. E. Morton (1988). “Resource Pricing and Aggregate Scheduling in Manufacturing Systems” Unpublished paper, GSIA, Carnegie-Mellon University.
Tardif, V. and M. L. Spearman (1997). “Diagnostic Scheduling in Finite-Capacity Production Environments” Computers and Industrial Engineering, Vol. 32, No. 4, pp. 867-878.
Thomas, L. J and J. O. McClain (1993). “An Overview of Production Planning”, Handbooks in Operations Research & Management Science Vol 4: Logistics of Production and Inventory, S. C. Graves, A. H. G. Rinnooy Kan and P. Zipkin (eds.), pp. 333-370.
Vollman, T. E., Berry, W. L. and D. C. Whybark, Manufacturing Planning and Control Systems, 2nd edition, Richard D. Irwin, Inc. (1988).

1. A method for production planning in capacitated supply chains using non-linear clearing functions, comprising:
determining a time period for measurement;
defining an unambiguous work-in-process (WIP) to represent the WIP over the time period;
utilizing the defined WIP to define an estimated clearing function;
applying the estimated clearing function to the production system under analysis;
analyzing the current conditions of the production system; and
releasing work into the production system based on the analysis.

2. A system comprising:
a computing platform including software operable on the platform to:
determine a time period for measurement in a production planning environment;
define an unambiguous work-in-process (WIP) to represent the WIP over the time period;
utilize the defined WIP to define an estimated clearing function;
apply the estimated clearing function to the production system under analysis;
analyze the current conditions of the production system; and
release work into the production system based on the analysis.
